(19) United States
(12) Patent Application Publication
(10) Pub. No.: US 2005/0157671 A1
(43) Pub. Date: Jul. 21, 2005

(54) Radio communication device and control data retreiving method

(75) Inventor: Toshiyuki Sugitani, Miyaki-gun (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/996,445

(22) Filed: Nov. 26, 2004

(30) Foreign Application Priority Data
Nov. 27, 2003 (JP) 2003-396903
Dec. 4, 2003 (JP) 2003-405386

(51) Int. Cl. H04B 7/212

(52) U.S. Cl. 370/324; 370/321

(57) ABSTRACT

The invention provides a radio communication device for carrying out a time division communication, thereby communicating with a base station for transmitting control data, wherein when an intermittent receiving operation is to be performed in order to capture the control data transmitted from the base station during a standby, the receiving operation of the radio portion is started to periodically receive the control data of the base station, the receiving operation is stopped if the control data cannot be received for a predetermined receipt period, the receiving operation is then restarted repetitively after a predetermined halt period passes, and a receiving period in the intermittent receiving operation is switched to be short if the control data cannot be captured for a predetermined period. Consequently, the consumed current of a retrieving operation can be reduced in an environment in which a signal sent from the base station cannot be received, and the control data can be received early when a receivable state is brought, and thus, a return to a standby state can be carried out immediately and quickly.

### BACKGROUND OF THE INVENTION

1. Field of the Invention

The present invention relates to a radio communication device for carrying out a communication by a radio signal and a control data retrieving method in the radio communication device.

2. Description of the Related Art

In a radio communication device using a TDMA method, a control signal (which will be hereinafter referred to as a “control signal” or “control data”) is periodically transmitted in a specific slot from a base station side, and the radio communication device during a standby receives a control slot transmitted from the base station and a large number of devices to be operated to wait for a call from the base station have been used practically.

For example, in a PHS developed in Japan, a base station transmits a control signal in a cycle of 100 msec, and a PHS terminal set in a standby state receives a control signal corresponding to an incoming call group which is transmitted from the base station and is determined by the telephone number of the PHS terminal, and waits for a call from the base station (see Second Generation Cordless Phone System Gauge Fourth Edition, Chapter IV (typical view Page 70 FIGS. 4. 2. 4)).

Referring to the PHS terminal, in the case in which a transition from a call state to a standby state for receiving a control signal is carried out or the case in which a one-time receiving state is deteriorated during the standby and the control signal is newly started to be received from a base station, a receiving frequency is first adapted to the transmitting frequency of the control signal of the base station to perform a continuous receipt, and a transition to an intermittent receiving operation corresponding to the transmitting cycle of the control signal is carried out when the control signal of the base station is captured, and a transition to the standby state is thus performed. In a mobile communication device such as the PHS terminal in which a battery driving operation is carried out in most cases, when the control signal of the base station cannot be received by a receiving operation for a constant time period, a receipt is stopped and the receiving operation is performed again after a certain time passes, and an operation for trying to receive the control signal of the base station is repeated to continuously retrieve the control signal of the base station in order to prevent the consumption of a battery.

In the case in which the radio communication device is present in an environment in which the base station cannot be captured but an operation is carried out to repeat a receiving operation for retrieving the base station and a receiving halt, thus, it is more advantageous that a time required for the receipt is shortened and a halt period is prolonged in respect of a consumed current. On the other hand, in the case in which the halt period is long, an outside-of-sphere state is brought until a next receiving operation for retrieving the base station is started also when the radio communication device returns to a place in which the control signal of the base station can be received. For this reason, the halt period cannot be prolonged too greatly. In order to solve this problem, there has been proposed a control method for shortening a halt period when a base station cannot be captured by a receiving operation and repeating the receiving operation and the receiving halt immediately after the start of the capture of the base station, and switching a control to prolong a time required for the receiving halt and gradually prolonging the time required for the receiving halt when repeating the receiving operation and the receiving halt after a constant time passes (see JP-A-2000-69552 Publication).

Moreover, a radio communication device using an ISM band has been increasingly developed, and there has been developed a radio communication device for carrying out a TDMA communication using a frequency hopping method to perform a communication while changing a communication frequency every frame as one of the communicating methods of the radio communication device having the frequency band.

Also in the standby operations of a base station and a terminal which are constituted by the radio communication device for carrying out the TDMA communication using the frequency hopping method, as described above, a control signal (control data) is(are) periodically transmitted in a specific slot from the base station side and the terminal during a standby is operated to receive a control slot transmitted from the base station and to wait for a call from the base station. Referring to the base station and the terminal in the frequency hopping method, the transmitting frequency of the control slot which is sent from the base station is changed at any time in accordance with a predetermined hopping pattern. On the terminal side, therefore, the control slot transmitted from the base station is received while a receiving frequency is changed corresponding to the hopping pattern of the base station.

In such a radio communication device using the frequency hopping method, the terminal is to sequentially receive a plurality of frequencies to be used for the transmission of the control data by the base station in order to capture the control data transmitted from the base station. As compared with the radio communication device using the TDMA in which the frequency hopping is not carried out, a receiving time required for retrieving the base station is prolonged so that a consumed current is increased. For this reason, conventionally, there has been employed a method for lessening the consumed current in the retrieval of the base station in which approximately three types of fixed frequencies are selected without the retrieval of all of the frequencies to be used for transmitting the control data by the base station and only the frequency thus selected is retrieved, and the retrieval of the base station is halted when the receipt cannot be carried out and a retrieval and an interruption based on a predetermined frequency are repeated in order to retrieve the frequency retrieved earlier again after a constant time passes.

For example, in a radio LAN using a frequency dispersion method for an ISM band, a frequency is selected in three portions, that is, a portion having a small frequency band, a central portion and a portion having a large frequency band in the retrieval of a base band in consideration of a communication error made by a radio interference, and the base station is thus retrieved.

In the conventional radio communication device, thus, the base station is retrieved repetitively in an environment in which a signal sent from the base station cannot be received, and a halt period is prolonged in a middle or is sequentially prolonged when the receipt and the halt for retrieving the base station are to be repeated in order to prevent an increase in a consumed current. In the case in which the base station cannot be received for a long period of time, therefore, the start of a next retrieval for the base station is delayed even if the base station is moved to an environment in which it can be received. Thus, there is a problem in that a return to the standby state is delayed.

In the radio communication device using the TDMA method using the frequency hopping, moreover, the base station is retrieved at a plurality of predetermined frequencies in consideration of the disturbance of a radio LAN while controlling a consumed current in the retrieval of the base station. In the environment in which a plurality of radio LANs is present, however, there is a possibility that all of the fixed frequencies which are selected might be subjected to an interference. Therefore, there is a problem in that it is hard to retrieve the base station in some cases. In the case in which the number of frequencies to be received is increased in order to lessen the danger of a receiving error which is caused by the interference, moreover, there is a problem in that the consumed current is increased in a situation in which a signal sent from the base station cannot be received even if a disturbance is not caused by the interference.

### SUMMARY OF THE INVENTION

It is an object of the invention to provide a radio communication device capable of reducing the consumed current of a retrieving operation in an environment in which control data cannot be received from a base station, and a control data retrieving method for reducing the consumed current of the retrieving operation in the environment in which the control data cannot be received from the base station.

In order to solve the problems, the invention provides a radio communication device having such a structure as to carry out a time division communication, thereby communicating with a base station for transmitting control data and to receive the control data of the base station during a standby, wherein when an intermittent receiving operation is to be carried out in order to capture the control data transmitted from the base station during a standby, a radio portion is controlled to start a receiving operation of the radio portion so as to receive the control data of the base station, to stop the receiving operation if the control data cannot be received for a predetermined receiving period, and to then restart the receiving operation after a predetermined halt period passes, and to stepwise shorten the receiving period if the control data transmitted from the base station cannot be captured for a predetermined period.

Consequently, it is possible to obtain the radio communication device capable of reducing the consumed current of a retrieving operation when it is put in the environment in which the control data transmitted from the base station cannot be received, that is, it is put on the outside of the sphere of the base station, and quickly receiving the control data from the base station when the base station is changed into a receivable state, and returning to a standby state immediately and rapidly.

In a radio communication device for carrying out a communication by using a frequency hopping method, moreover, when an intermittent receiving operation is to be carried out in order to capture the control data transmitted from the base station during a standby, the radio portion is controlled to start a receiving operation of the radio portion in order to receive any of frequencies used in the transmission of the control data of the base station and to stop the receiving operation if the control data cannot be received for a predetermined receiving period, and to then restart the receiving operation after a predetermined halt period passes, and is controlled to switch a receiving period of the intermittent receiving operation to be short and to decrease the number of frequencies to be selected for the receiving period if the control data transmitted from the base station cannot be captured for a predetermined period.

### BRIEF DESCRIPTION OF THE DRAWINGS

FIG. 1 is a block diagram showing a radio communication device according to a first embodiment of the invention, FIG. 2(a) is a timing chart showing the transmitting timing of the control data of a base station, FIG. 2(b) is a timing chart showing a receiving timing in the radio communication device (terminal), and FIG. 2(c) is a timing chart showing a retrieving timing in the radio communication device (terminal),

FIG. 3(a) is a timing chart showing the transmitting timing of the control data of the base station, and FIG. 3(b) is a timing chart showing a retrieving timing in the radio communication device,

FIG. 4 is a flowchart showing the operation of the radio communication device in FIG. 1,

FIG. 5 is a block diagram showing a radio communication device according to a second embodiment of the invention,

FIG. 6(a) is a timing chart showing a retrieving timing, FIG. 6(b) is a timing chart showing the retrieving timing, and FIG. 6(c) is a timing chart showing the retrieving timing,

FIG. 7 is a flowchart showing the operation of the radio communication device in FIG. 5,

FIG. 8 is a block diagram showing the radio communication device according to the first embodiment of the invention,

FIG. 9 is a timing chart showing a TDMA frame and slot and frequency hopping which are used in a communication between the radio communication device in FIG. 8 and a base station,

FIG. 10(a) is a timing chart showing the transmitting timing of control data from the base station and FIG. 10(b) is a timing chart showing a receiving timing in the radio communication device,

FIG. 11 is a timing chart showing an operation in which the radio communication device retrieves the transmitting signal of the control data of the base station and cannot receive the control data of the base station but repeats a retrieval and a stop, and

FIG. 12 is a flowchart showing an operation in which the radio communication device retrieves the transmitting signal of the control data of the base station and cannot receive the control data of the base station but repeats the retrieval and the stop.

### DESCRIPTION OF THE PREFERRED EMBODIMENTS

### First embodiment

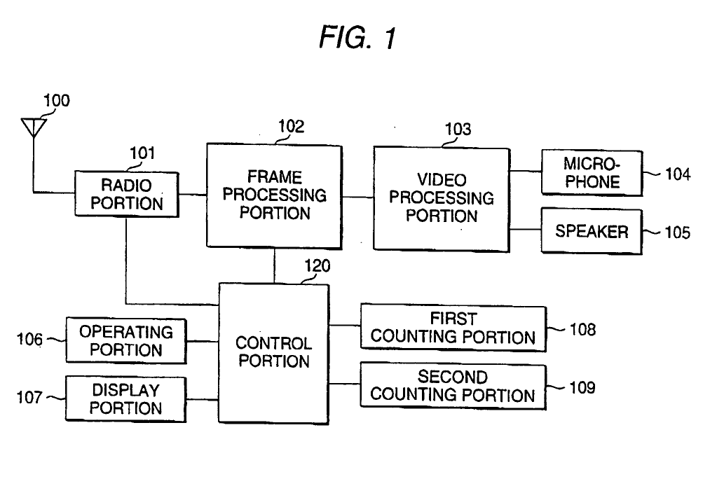

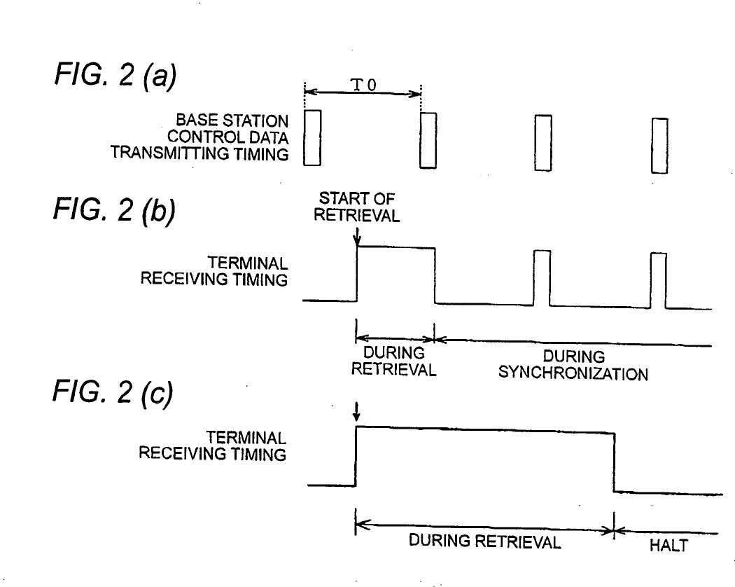

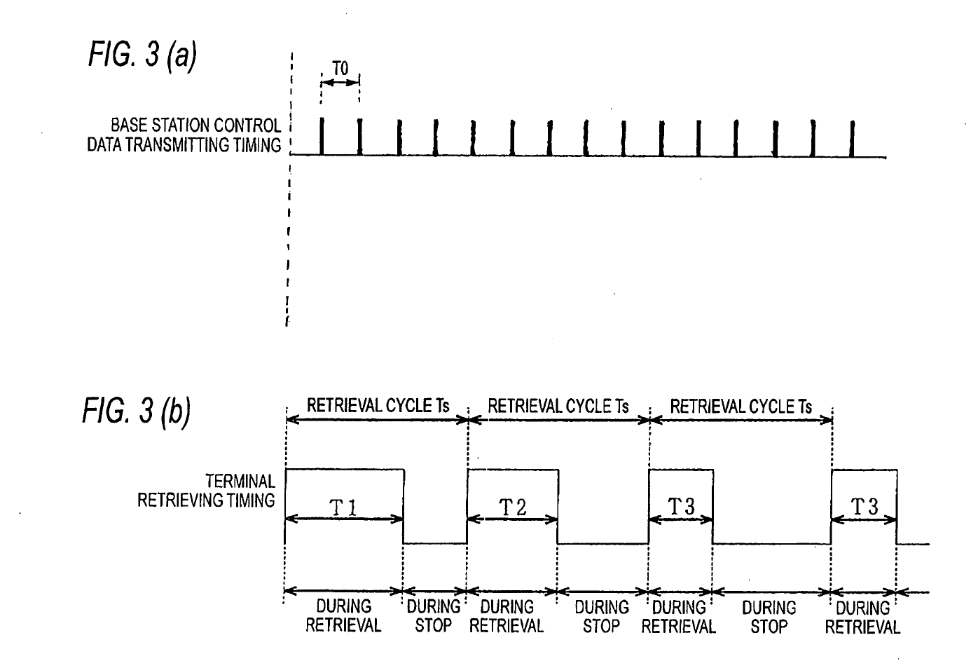

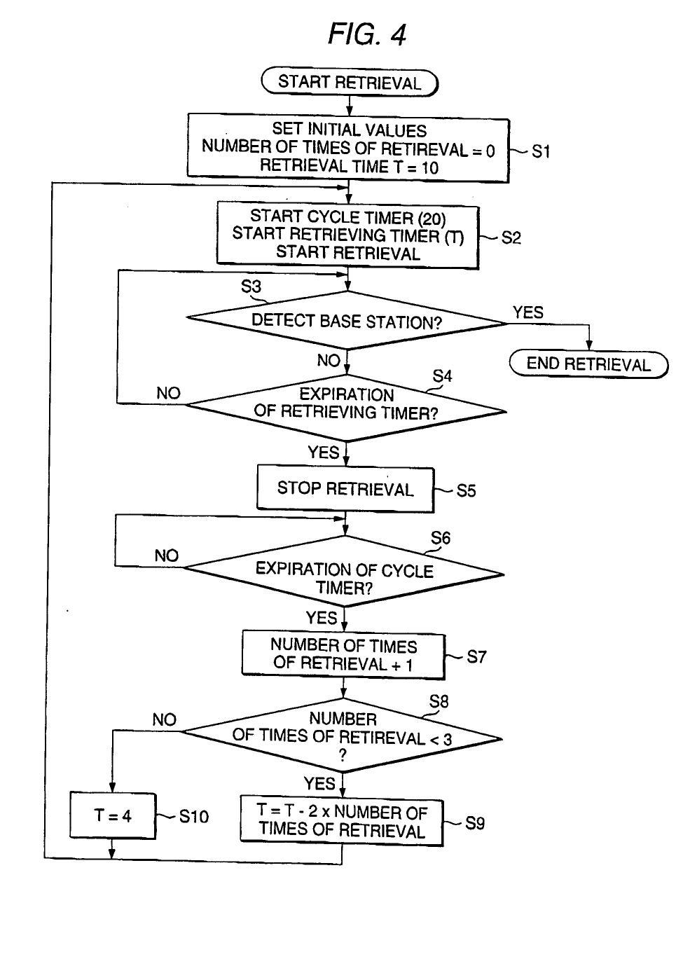

FIG. 1 is a block diagram showing a radio communication device according to a first embodiment of the invention, FIG. 2(a) is a timing chart showing the transmitting timing of the control data of a base station, FIG. 2(b) is a timing chart showing a receiving timing in the radio communication device (terminal), FIG. 3 is a timing chart showing a retrieving timing in the radio communication device, and FIG. 4 is a flowchart showing the operation of the radio communication device in FIG. 1.

In FIG. 1, 100 denotes an antenna for inputting/outputting a radio signal to/from a base station (not shown), 101 denotes a radio portion for generating a radio signal obtained by modulating transmission data so as to be transmitted and demodulating the radio signal which is received, 102 denotes a frame processing portion for generating a data column to be transmitted in one slot of TDMA by adding bit synchronization data, frame synchronization data or an error detection code to the transmission data, fetching voice data or control data from the received signal and carrying out an error decision, and performing an output, and 103 denotes a voice processing portion for digitally converting an analog voice signal to be transmitted and converting the received voice data to an analog voice signal. 104 denotes a microphone for inputting the voice signal and 105 denotes a speaker for outputting the voice signal. 106 denotes an operating portion for inputting a telephone number and 107 denotes a display portion for displaying the input telephone number, a date and time, a call time, the operation state of a radio communication device, and the residual quantity of a battery. 108 denotes a first counting portion for counting a retrieval time in the retrieval of a base station, and 109 denotes a second counting portion for counting the starting cycle of the retrieval of the base station, 120 denotes a control portion for controlling the whole device.

The radio communication device shown in FIG. 1 can carry out a communication in a voice with another telephone or radio communication device through the base station. When giving a call from the radio communication device to another device, a user inputs and sends the telephone number of the other party and a call key for giving a request for a call through the operating portion 106. The control portion 120 transmits a control signal for calling a base station to the frame processing portion 102 when the sending operation is carried out by the operating portion 106. The frame processing portion 102 adds bit synchronization data, frame synchronization data and an error detection code to control data transmitted from the control portion 120 corresponding to the receiving timing of the base station and outputs them to the radio portion 101, and a data column output from the frame processing portion 102 is converted to a radio signal through the radio portion 101 and is then transmitted from the antenna 100.

The control portion 120 controls the radio portion 101 and the frame processing portion 102 to wait for a response from the base station, receives the response from the base station, and executes the exchange of the control data for a call connection after receiving the response from the base station. Moreover, the control portion 120 carries out a control to start a voice call when getting, from the base station, a notice that the other party gives the response.

The received voice signal is subjected to an analog conversion through the voice processing portion 103 and is then output from the speaker 105. A voice signal input from the microphone 104 is subjected to a digital conversion through the voice processing portion 103 and is converted to a radio signal in the radio portion 101 after the processing of the frame processing portion 102, and is then output. Thus, a voice call is started.

When a call is given from another device to the radio communication device in FIG. 1, moreover, the base station transmits control data for giving the notice of an incoming call to the radio communication device. Upon receipt of the control data for giving the notice of the incoming call, the radio communication device exchanges the control data of a call control together with the base station in the same manner as the sending operation. The control portion 120 controls the display portion 107 to display to give the notice of the incoming call and controls to start a voice call when the user performs an operation for responding to the incoming call from the operating portion 106. In the sending operation and the incoming call operation, a radio transmission and receipt between the base station and the radio communication device is carried out by using a TDMA method. Therefore, it is necessary to synchronize each of the transmission and the receipt. For this reason, the base station periodically transmits a radio signal and the radio communication device establishes the synchronization of a frame and a slot in the TDMA method with the base station on the basis of the same signal. A synchronization signal to be periodically transmitted by the base station (which will be hereinafter referred to as a “control channel”) includes necessary information for the radio communication device to establish the synchronization of the frame and slot of the TDMA of the base station, for example, slot information indicative of a slot in which a control channel is transmitted or ID information about the base station carrying out the transmission. Moreover, the notice of the incoming call to the radio communication device is also given through the control channel. The radio communication device retrieves the control channel of the base station in order to select any of commutable base stations which has an excellent receiving state in a transmission, and executes to give a request for a call to a base station having a high receiving level. Moreover, the radio communication device carries out the receipt of the control channel in order to receive a call from a base station for an incoming call in a state other than the call.

Next, description will be given to the retrieving operation of the control channel of the base station to be started when the receiving state of the control channel of the base station during a standby is deteriorated in the start of the call of the radio communication device or a transition to a standby operation to be carried out after the end of the call.

The base station periodically transmits the control channel at a predetermined frequency as described above. In order to receive the control channel, the control portion 120 sets the receiving frequency of the radio portion 101 in order to receive a signal having the transmitting frequency of the control channel and brings a receiving state. The control channel transmitted from the base station is demodulated by the radio portion 101 through the antenna 100 and is then transmitted to the frame processing portion 102. The frame processing portion 102 extracts control data included in the control channel based on frame synchronization data included in the demodulation data. The control data thus extracted are transmitted to the control portion 120 if a receiving error is not made, and the control data are analyzed in the control portion 120 so that a base station ID and slot information are fetched. In the case in which a communication with a pertinent base station is started, subsequently, the control portion 120 controls the radio portion 101 and the frame processing portion 102 to determine transmitting and receiving timings based on the control slot timing and the slot information which are received, thereby starting a communication. In the case in which a transition to a synchronization state with the pertinent base station is carried out, moreover, the control portion 120 controls the radio portion 101 and the frame processing portion 102 to receive the control channel corresponding to the transmitting cycle of the control channel of the base station. The control portion 120 manages a time required for retrieving the control channel of the base station in addition to the control in order to receive the control channel of the base station.

In the case in which the retrieval of the control channel is started, for example, a base station cannot be received at the end of a call or during a standby so that another base station is changed to stand by, the control portion 120 starts to receive the control channel as described above, and at the same time, sets a retrieval time to the first counting portion 108 and sets a retrieval cycle to the second counting portion 109 so that counting operations for measuring a time are started respectively. The counting is advanced in the first counting portion 108 and the second counting portion 109 while the control channel is received. When a value set earlier is reached, the notice of the expiration of a time is given to the control portion 120.

In the case in which the control channel of the base station cannot be received within a retrieval time counted by the first counting portion 108, that is, the notice of the expiration of the time is given from the first counting portion 108 to the control portion 120, the control portion 120 stores that the retrieving operation at a first time cannot be received, and at the same time, controls to bring the radio portion 101 and the frame processing portion 102 into a receiving stop state. When the notice of the expiration of the time in the retrieval cycle is given from the second counting portion 109 to the control portion 120, then, the control portion 120 controls the radio portion 101, the frame processing portion 102, the first counting portion 108 and the second counting portion 109 in the same manner as described above in order to carry out the retrieving operation again. At this time, the value to be set to the first counting portion 108 is smaller than a value set at a last time.

Subsequently, an operation is carried out to receive the control channel for the time period counted by the first counting portion 108 at a time interval counted by the second counting portion 109 in the same manner as described above until the control channel of the base station can be received.

While the control portion 120 carries out a control to repeat the receipt and the receipt stop in accordance with the notices of the expiration of the time which are given from the first counting portion 108 and the second counting portion 109 until the control channel of the base station is received after the start of the retrieval of the base station, the setting of the first counting portion 108 is carried out in such a manner that a time required for the receipt is more shortened every time the receipt for the retrieval is repeated. After the receipt and the stop are repeated at a predetermined number of times or more, the receipt time set to the first counting portion 108 is caused to have a fixed value. At this time, the receipt time is prevented from being shorter than the transmitting cycle of the control channel of the base station. Also in the case in which the base station cannot be received for a long period of time but the receipt and the stop are repeated, a time required for the receiving operation to retrieve the base station is set in such a manner that there is always a timing to be coincident with the transmitting timing of the base station for the receipt time in the start of the receipt.

Next, an operation for the radio communication device to retrieve the control channel of the base station and to carry out a transition to a standby will be described with reference to FIG. 2.

In the example shown in FIG. 2, the base station transmits the control channel at a time interval of T0. (a) shows a timing for causing the base station to transmit the control channel, and the base station transmits the control channel at the time interval of T0. As shown in (b), the radio communication device is first operated to bring the receiving circuit of the radio portion 101 into a state in which the control channel is received when the retrieving operation is started, and consequently, a continuous receiving state is brought. When the control channel of the base station is received, then, the continuous receipt is stopped. Subsequently, the receiving operation is carried out in only the transmitting timing of the control channel corresponding to the transmitting cycle of the control channel of the base station. (c) shows the case in which the radio communication device cannot receive the control channel of the base station because a radio wave cannot arrive, and there is carried out a transition to an intermittent receiving state in which the receiving state is continuously set for a predetermined period and the receiving operation is then stopped, and is restarted after a receiving stop state is set for a predetermined period.

Next, an operation to be carried out in the case in which the control channel of the base station cannot be received will be described in detail with reference to FIG. 3.

In FIG. 3, (a) shows a timing for causing the base station to transmit the control channel. In the case in which the control channel of the base station cannot be received, the radio communication device first carries out a receipt for T1 in a first retrieval and stops the receipt when starting the retrieval of the base station as shown in (b). Then, a control is carried out to perform the receipt for T2 which is shorter than T1 in a second retrieval, the receipt for T3 which is shorter than T2 in a third retrieval, and a retrieval for the constant time period of T3 in a subsequent retrieval. Moreover, respective retrieval starting cycles are constant for T0 and a receiving operation for a retrieval is started every constant cycle: T0. Since the retrieval cycle is constant, a time required for the receipt stop in each receiving operation is more prolonged corresponding to a reduction in the time required for the receiving operation.

The control of the receipt time for retrieving the control channel of the base station includes a method for shortening a time every constant number of times, a method for setting the receipt time to be long until the receipt is carried out at a constant number of times and subsequently shortening the same receipt time sequentially or a method for setting the receipt time to be long until the receipt is carried out at a certain number of times and subsequently setting the receipt time to be short in addition to a method for shortening the time every receipt as in the example described above. By carrying out a control to change the receipt time to be short in any timing after the start of the retrieval, an increase in a consumed current is suppressed in the execution of the receipt for retrieving the base station in an environment in which the control channel of the base station cannot be received.

Next, description will be given to an operation for combining a control to repeat a retrieving operation without receiving the control channel of a base station and another control to be periodically carried out, thereby reducing a consumed current.

When the radio communication device shown in FIG. 1 is set into a state in which the control channel of the base station cannot be received, it carries out a periodic control such as the display refresh of an LCD or the calculation of the residual quantity of a battery in addition to a control for retrieving the control channel of the base station in the above description.

The radio communication device is set in the receiving stop state in a section during the receiving operation for a retrieval in a state in which the retrieval of the base station is repeated, and the CPU of the control portion 120 for controlling the device to reduce the consumed current is brought into a state in which the processing is temporarily stopped (hereinafter referred to as a “HALT state”). When the next timing of the retrieval of the base station arrives in this state, the CPU is started by an interruption processing so that a receiving operation is started. At this time, the CPU controls the radio portion 101 to start the receipt, and subsequently, executes a periodic processing such as the display refresh of an LCD or the calculation of the residual quantity of a battery.

When the receipt processing and the periodic processing such as the display refresh of the LCD or the calculation of the residual quantity of the battery are completed, then, the CPU is brought into the HALT state again. Thus, the radio communication device employs a method for periodically executing a large number of control operations, and furthermore, bringing the CPU into the HALT state when the CPU does not need to carry out any processing in order to reduce the consumed current, thereby restarting the CPU through a timer interruption. In the case in which the operation for retrieving the base station is to be carried out in a constant cycle in a state in which the control channel of the base station cannot be received, it is easy to combine another control to be carried out periodically and a control of the retrieving operation and to perform a processing. Consequently, it is possible to decrease the number of times of the processing for carrying out a transition from the HALT state to the starting state over the CPU. Thus, it is possible to reduce the load and operating current of the CPU through the processing.

Next, a retrieving method for causing the radio communication device in FIG. 1 to retrieve the base station (a control data retrieving method) will be described with reference to FIG. 4.

A flowchart in FIG. 4 shows a control flow in the case in which the radio communication device retrieves the control channel of a base station when it is hard to receive the control channel of the base station at time of power ON, after the end of a call or during a standby.

When the control channel of the base station is started to be retrieved, the number of times of the retrieval and an initial retrieval time T are first set to be the setting of initial values (S1). In the embodiment, the initial retrieval time is set to be 10 seconds. Subsequently, a cycle timer for counting a retrieval cycle and a retrieval timer for counting a retrieval time are started and respective elapsed times are started to be counted, and furthermore, there is executed a control for a start of a retrieval, that is, a control for setting the receiving circuit of the radio portion 101 into a state in which the control channel of the base station can be received and bringing a receiving operation state (S2).

In the embodiment, the set value of the retrieval cycle timer which is set at the step S2 is set to be 20 seconds. Moreover, the value of the retrieval time T set at the step S1, that is, 10 seconds is/are set to be the set value of the retrieval timer which is set in the step S2 at an initial time. After the start of the retrieval, it is decided whether or not the base station can carry out the receipt (S3) and it is decided whether or not the retrieval timer expires (S4). If the base station is received during the receiving operation, “Yes” is obtained in the decision as to whether or not the base station can be received (S3) so that the retrieval is ended, and subsequently, the processing proceeds to an intermittent receiving operation which is synchronous with the transmitting timing of the control channel of the base station (not shown).

If the state in which the control channel of the base station cannot be received is maintained continuously, the base station is successively detected until the retrieval timer expires. If the retrieval timer expires, “Yes” is obtained at the step S4 in which it is decided whether or not the retrieval timer expires so that the processing proceeds to a control for stopping the retrieval, that is, a control for stopping the receipt (step S5). After the retrieval is stopped, it is decided whether or not the cycle timer expires (S6).

If the cycle timer expires, “Yes” is obtained at the step S6 in which it is decided whether or not the cycle timer expires, and the processing proceeds to a step S7 in which the number of times of the retrieval is counted up. Then, the number of times of the retrieval is decided (S8) and it is decided whether or not the number of times of the retrieval reaches a specified number of times. If the number of times of the retrieval is smaller than the specified number of times, the processing proceeds to a step S9 in which the retrieval time is changed corresponding to the number of times of the retrieval. If the number of times of the retrieval is equal to or greater than the specified number of times, the processing proceeds to a step S10 in which the retrieval time is set to have a fixed value.

In the embodiment, it is assumed that the specified number of times for the number of times of the retrieval to be decided at the step S8 is set to be four A control is carried out in such a manner that the retrieval time is decreased every two seconds if the number of times of the retrieval (the number of times of a retrieval retrial) does not reach the specified number of times, and the retrieval time is set to be four seconds after the number of times of the retrieval reaches the specified number of times. In the embodiment, accordingly, a next retrieval time is set to be 8 seconds if the retrieval time at a first time expires. After the next retrieval time is set at the step S9 or the step S10, the processing returns to the step S2 in which the cycle timer for counting the retrieval cycle set to have the same value as a last value and the retrieval timer for counting the retrieval time set to have the value of the retrieval time set at the step S9 or the step S10 are started and the respective elapsed times are started to be counted, and furthermore, there is executed a control for the start of the retrieval, that is, a control for setting the receiving circuit into the state in which the control channel of the base station can be received and bringing the receiving operation state.

Subsequently, the receiving operation for a time determined by the retrieval time T is repeated at a time interval set to the cycle timer until the control channel of the base station is received. In case of the embodiment, accordingly, the receipt of the retrieval of the base station is started at an interval of 20 seconds and the receiving operation is continuously carried out for 10 seconds at a first time, 8 seconds at a second time, 6 seconds at a third time and 4 seconds at a fourth time and succeeding times.

While the example in which the setting of the retrieval time corresponding to the number of times of the retrieval is uniformly decreased corresponding to the retrieval time has been described in the embodiment, a method for first decreasing a rate at which the retrieval time is shortened and gradually increasing the rate is also effective. For example, a control is carried out in such a manner that the retrieval time for the first time is set to be 10 seconds, the retrieval time for the second time is set to be 9 seconds, the retrieval time for the third time is set to be 7 seconds, and the retrieval times for the fourth time and succeeding times are set to be 4 seconds. In this case, the receipt time is set to be long immediately after a new operation for retrieving the control channel of the base station is started. In the case in which the retrieving operation is started in the state in which the control channel of the base station can be received, for example, at time of the end of a call or a change in a standby to another base station within the area of the base station, therefore, it is decided that a signal sent from the base station cannot be received and the receipt is stopped when the control channel of the base station cannot be received due to a temporary reduction in a receiving level by fading or the temporary generation of a receiving error which is caused by a disturbance due to a radio interference. Consequently, there is a small danger that a return to the standby state might be delayed. Thus, the convenience of the user can be enhanced, and furthermore, the receipt time can be shortened earlier in the case in which the state in which the control channel of the base station cannot be received is maintained continuously. Consequently, it is possible to increase the effect of reducing the consumed current.

While two branches are provided based on the number of times of the retrieval at the step S8 in the embodiment, moreover, a plurality of branches can also be provided to determine the retrieval time corresponding to the larger number of times of the retrieval. For example, it is also possible to carry out such a control that the retrieval time for the number of times of the retrieval which is smaller than 10 is set to be 10 seconds, the retrieval time for the number of times of the retrieval which is equal to or greater than 10 and is smaller than 100 is set to be 7 seconds, and the retrieval time for the number of times of the retrieval which is equal to or greater than 100 is set to be 4 seconds.

While the example of the control flow for proceeding to each step while deciding the result of the detection of the base station or the expiration of the timer through the CPU has been described in the embodiment, furthermore, it is also possible to proceed to a step based on an interruption processing. More specifically, it is also possible to employ a method in which the CPU starts the cycle timer and the retrieval timer at the step S2 and a transition to the HALT state is carried out when the radio portion 101 is brought into the receiving operation state, and the CPU is restarted by an interruption for giving the notice of the receipt of the base station from hardware (for example, the frame processing portion according to the first embodiment) and a transition to a retrieval ending state is carried out, and furthermore, the CPU is restarted by the interruption of the expiration of the retrieval timer to proceed to the step S5, the CPU is brought into the HALT state after the stop of the receipt, and the CPU is restarted by the interruption of the expiration of the cycle timer to proceed to the step S7.

As described above, according to the embodiment, there are provided the first counting portion 108 for counting a time required for receiving the control data transmitted periodically from the base station and the second counting portion 109 for counting an interval required for receiving the control data transmitted periodically from the base station, and the control portion 120 can periodically control the radio portion 101 to receive the control data of the base station for a time determined by the first counting portion 108 in order to capture the control data when carrying out the intermittent receiving operation, can control the radio portion 101 to receive the control data of the base station for the time determined by the first counting portion 108 again at a time interval determined by the second counting portion 109 when the control data cannot be received, and can shorten the time counted by the first counting portion 108 when the control data of the base station cannot be received but the receipt is repeated. Consequently, it is possible to shorten the time required for consuming a current in the receipt for retrieving the base station in the environment in which the signal cannot be received from the base station. Thus, it is possible to lessen the current to be consumed for retrieving the base station.

In the case in which the temporary receiving error of the base station is generated at the start of the retrieval, moreover, the control is carried out to prolong the retrieval time at the start of the retrieval. It is decided that the signal cannot be received from the base station and the retrieval is thus stopped. Thus, it is possible to lessen the delay of the return to the standby state.

By setting the starting cycle of the start of the retrieval to be constant and repeating the retrieval and the halt in the environment in which the signal sent from the base station cannot be received, furthermore, it is possible to decrease the delay of the return to the standby state when bringing the state in which the receipt can be carried out, and at the same time, to enhance the sharing property of the timer control with another control to be started periodically and to reduce an increase in a CPU load and an increase in a consumed current which is incidental thereto irrespective of a duration for the state in which the receipt cannot be carried out.

### Second Embodiment

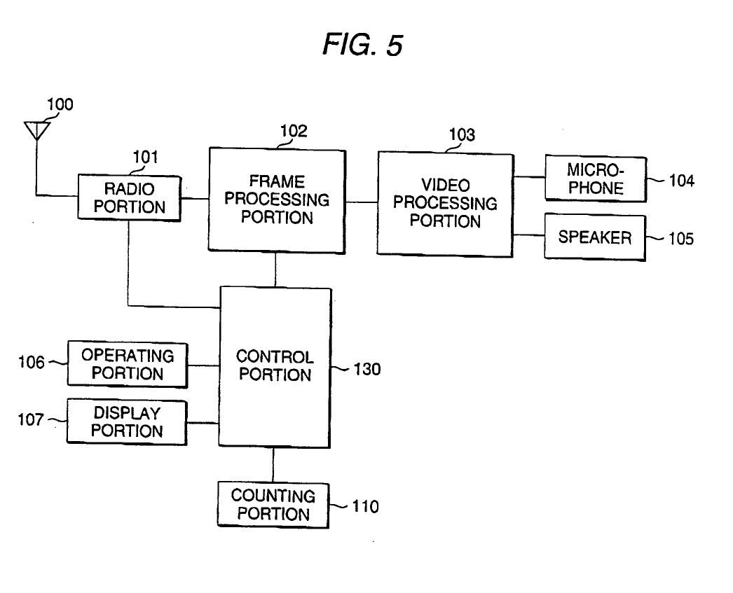

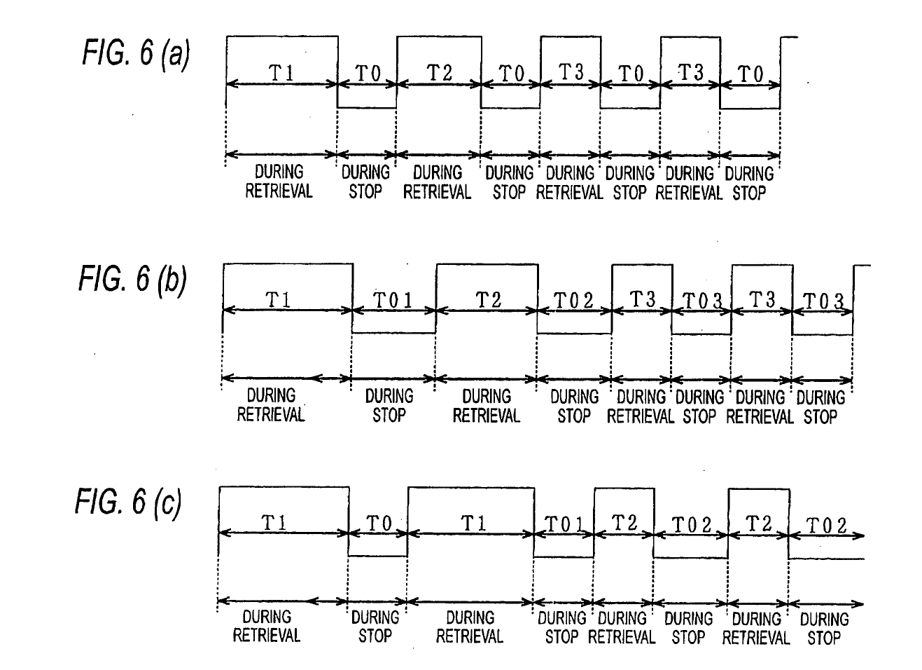

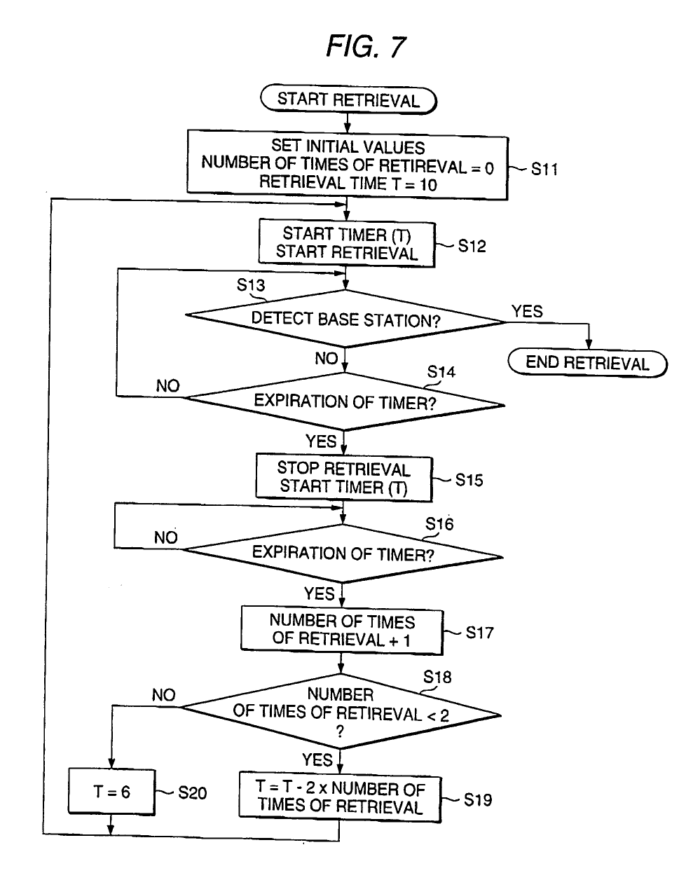

FIG. 5 is a block diagram showing a radio communication device according to a second embodiment of the invention, FIGS. 6(a), (b) and (c) are timing charts showing a retrieving timing, and FIG. 7 is a flowchart showing the operation of the radio communication device in FIG. 5.

In FIG. 5, since an antenna 100, a radio portion 101, a frame processing portion 102, a voice processing portion 103, a microphone 104, a speaker 105, an operating portion 106 and a display portion 107 are the same as those in FIG. 1, they have the same reference numerals and description thereof will be omitted. 110 denotes a counting portion for counting a retrieval time and a stop time during the retrieval of a base station in the retrieval of the base station, and 130 denotes a control portion for controlling the whole device. An operation to be carried out during a communication in the radio communication device in FIG. 5 and an operation in which an operation for receiving the control channel of the base station is carried out, the control channel is received and a transmission to an intermittent receipt which is synchronous with the control channel is performed are the same as those in the first embodiment, and description will be omitted. Description will be given to an operation to be carried out when the radio communication device in FIG. 5 cannot receive the control channel of the base station but repeats the receiving operation.

In the case in which the radio communication device in FIG. 5 retrieves the control channel of the base station, the control portion 130 controls the radio portion 101 and the frame processing portion 102 to be brought into such a state as to receive the control channel of the base station. Consequently, the receiving operation for retrieving the base station is started in the radio portion 101 and the frame processing portion 102, and furthermore, the control portion 130 sets a retrieval time to the counting portion 110 so that the retrieval time is started to be counted by the counting portion 110. Before the notice of the expiration of the retrieval time is given from the counting portion 110 to the control portion 130, the control channel of the base station is received. When the notice of the receipt of the control channel is given from the frame processing portion 102 to the control portion 130, the control portion 130 gives a notice to the counting portion 110 in order to stop the counting operation of the counting portion 110. Subsequently, the control portion 130 controls the radio portion 101 and the frame processing portion 102 to carry out an intermittent receipt corresponding to the transmitting cycle of the control channel transmitted from the base station.

When the control channel of the base station is not received but the retrieval time counted by the counting portion 110 expires and the notice of the expiration of the retrieval time is given from the counting portion 110 to the control portion 130, the control portion 130 controls the radio portion 101 and the frame processing portion 102 to stop the receipt of the control channel of the base station so that the receiving operation for retrieving the base station is stopped in the radio portion 101 and the frame processing portion 102. Thereafter, the control portion 130 sets a retrieval stop time to the counting portion 110 and the retrieval stop time is started to be counted by the counting portion 110.

When the retrieval stop time counted by the counting portion 110 expires and the notice of the expiration of the retrieval stop time is given from the counting portion 110 to the control portion 130, then, the control portion 130 controls the radio portion 101 and the frame processing portion 102 to be brought into a state in which the control channel of the base station is to be received in order to restart the receipt of the control channel of the base station. Consequently, a receiving operation for retrieving the base station is started in the radio portion 101 and the frame processing portion 102. The control portion 130 sets the retrieval time to the counting portion 110 so that the retrieval time is started to be counted by the counting portion 110. At this time, the retrieval time set to the counting portion 110 is set to be shorter than a time set earlier.

Subsequently, the receiving operation and the stop are repeated while gradually shortening the time required for the receiving operation corresponding to the retrieval time and the retrieval stop time which are counted by the counting portion 110 until the control channel of the base station is received. The control portion 130 carries out a control in such a manner that the retrieval time becomes constant after the receiving operation and the stop are repeated at a certain number of times. In this case, a retrieval time required for carrying out the shortest receiving operation is selected to be longer than the transmission interval of the control channel of the base station.

In the case in which the receiving operation and the stop for the retrieval are repeated as described above, moreover, a halt period counted by the counting portion 110 may be controlled variably. More specifically, it is also possible to employ a method for gradually shortening a halt period and starting the receiving operation for retrieving the base station earlier when the receipt of the base station can be carried out for the halt period, thereby returning to a standby state (a state in which an intermittent receipt is performed synchronously with the control channel of the base station). In this case, in order to reduce the consumed current in the repetition of the receiving operation and the stop for retrieving the control channel of the base station, it is necessary to vary the receipt time and the stop time in such a manner that the rate of occupation of the stop time is increased in a ratio of the time required for the receiving operation and the stop time in the case in which the receiving operation and the stop are repeated.

For example, the receipt time and the stop time are controlled in such a manner that the receipt time is set to be 10 seconds and the stop time is set to be 5 seconds immediately after the start of the retrieval, and both the receipt time and the stop time are finally set to be 1 second. In this case, the ratio of the receipt time to the stop time at the start of the retrieval is 2:1 and a final ratio is 1:1, and the mean value of the consumed current for a total period of the receiving operation and the stop time is reduced. In the case in which a control for varying the halt period is to be carried out, moreover, the control may be performed to gradually prolong the halt period. For example, the control for varying the receipt time and the stop time is carried out in such a manner that the receipt time is set to be 10 seconds and the stop time is set to be 5 seconds immediately after the start of the retrieval, and finally, the receipt time is set to be 1 second and the stop time is set to be 10 seconds. In this case, the ratio of the receipt time to the stop time at the start of the retrieval is 2:1 and the final ratio is 1:10, and furthermore, an effect of reducing the consumed current can be obtained. Next, an example of a control timing in the repetition of the retrieval of the control channel of the base station and the stop in the radio communication device in FIG. 5 will be described with reference to FIG. 6.

FIG. 6(a) shows an example in which the stop period is set to be constant and the retrieval time is gradually shortened. In FIG. 6(a), the receiving operation for retrieving the base station is carried out for a time period of T1 immediately after the start of the retrieval. If the control channel cannot be received, the receipt is stopped for a time period of T0, and the receiving operation for retrieving the base station is then carried out for a time period of T2. In the case in which the control channel cannot be received again, the receipt is stopped for the time period of T0 and the receiving operation for retrieving the base station is then carried out for a time period of T3. Subsequently, the operation for retrieving the base station is carried out until the control channel is received while repeating the receipt stop for the time period of T0 and the receiving operation for the time period of T3. In the embodiment, the receiving operation for the retrieval is set to be T1>T2>T3, and the time required for the receiving operation is gradually shortened. Even if the state in which the control channel of the base station cannot be received is maintained continuously, therefore, it is possible to reduce the consumed current.

In the case in which the retrieving operation is started in a state in which the control channel of the base station can be received, for example, at time of the end of a call or a change in a standby for another base station within the area of the base station, a control is carried out to prolong the retrieval time immediately after the start of the retrieval when the control channel of the base station cannot be received due to a temporary reduction in a receiving level by fading or the temporary generation of a receiving error which is caused by a disturbance due to a radio interference. It is decided that a signal sent from the base station cannot be received, and the receipt is thus stopped. Consequently, there is a small danger that a return to a standby state might be delayed. Thus, the convenience of a user can be enhanced.

Moreover, the halt period of T0 is constant. Therefore, it is not necessary to carry out a processing of determining the halt period. Consequently, the processing can be relieved. When the state in which the base station can be received is brought, moreover, the standby state is always returned in a time period of T0 or less irrespective of the elapsed time from the start of the retrieval. Even if the state in which the signal cannot be received from the base station for a long period of time is set and the state in which the receipt can be carried out is then brought, the return to the standby state can be prevented from being delayed so that the convenience of the user can be enhanced. Furthermore, the retrieval time and the stop time can be measured by means of one timer and the circuit can be simplified.

FIG. 6(b) shows an example in which both the retrieval time and the stop time are gradually shortened. In FIG. 6(b), the receiving operation for retrieving the base station is carried out for the time period of T1 immediately after the start of the retrieval. In the case in which the control channel cannot be received, the receipt is stopped for a time period of T01 and the receiving operation for retrieving the base station is then carried out for the time period of T2. In the case in which the control channel cannot be received again, the receipt is stopped for a time period of T02 and the receiving operation for retrieving the base station is then carried out for the time period of T3. Subsequently, the receipt stop for a time period of T03 and the receiving operation for the time period of T3 are repeated, and the operation for retrieving the base station is then carried out until the control channel is received. At this time, both the retrieval time and the stop time are gradually shortened in such a manner that the rate of the receiving operation in the total time of the receiving operation and the stop time is gradually decreased. More specifically, the retrieval time and the stop time are controlled to obtain (T1/(T1+T01))>(T2/(T2+T02))>(T3/(T3+T03)).

As described above, in the embodiment, the retrieval time and the stop time are gradually shortened in such a manner that the rate of the receiving operation in the total time of the receiving operation and the stop time is gradually decreased. Even if the state in which the control channel of the base station cannot be received is maintained continuously, therefore, the consumed current can be reduced. In the case in which the retrieving operation is started in the state in which the control channel of the base station can be received, for example, at time of the end of a call or a change in a standby to another base station within the area of the base station, moreover, the control is carried out in such a manner that the retrieval time is prolonged immediately after the start of the retrieval when the control channel of the base station cannot be received due to a temporary reduction in the receiving level by fading or the temporary generation of a receiving error which is caused by a disturbance due to a radio interference. It is decided that a signal sent from the base station cannot be received, and the receipt is thus stopped. Consequently, there is a small danger that a return to the standby state might be delayed. Thus, the convenience of the user can be enhanced. Furthermore, the control is carried out in such a manner that the halt period for the retrieval is also shortened. Even if the state in which the signal sent from the base station cannot be received for a long period of time is set and the state in which the receipt can be carried out is then brought, therefore, the return to the standby state can be prevented from being delayed so that the convenience of the user can be enhanced. In addition, the retrieval time and the stop time can be measured by means of one timer. Thus, the circuit can be simplified.

FIG. 6(c) shows an example in which the retrieval time is shortened and the stop time is prolonged. In FIG. 6(c), the receiving operation for retrieving the base station is carried out for the time period of T1 immediately after the start of the retrieval. In the case in which the control channel cannot be received, the receipt is stopped for the time period of T0 and the receiving operation for retrieving the base station is then carried out for the time period of T01 again. In the case in which the control channel cannot be received, the receipt is stopped for the time period of T01. Thereafter, the receiving operation for retrieving the base station is started for the time period of T2. In the case in which the control channel cannot be received again, the receipt is stopped for the time period of T02 and the receiving operation for retrieving the base station is then carried out for the time period of T2. Subsequently, the receipt stop for the time period of T02 and the receiving operation for the time period of T2 are repeated, and the operation for retrieving the base station is thus carried out until the control channel is received. As described above, in the embodiment, the control is carried out in such a manner that the retrieval time is shortened and the stop time is prolonged. Even if the state in which the control channel of the base station cannot be received is maintained continuously, therefore, the consumed current can further be reduced. In the case in which the retrieving operation is started in the state in which the control channel of the base station can be received, for example, at time of the end of a call or a change in a standby to another base station within the area of the base station, moreover, the control is carried out in such a manner that the retrieval time is prolonged immediately after the start of the retrieval when the control channel of the base station cannot be received due to a temporary reduction in the receiving level by fading or the temporary generation of a receiving error which is caused by a disturbance due to a radio interference. It is decided that a signal sent from the base station cannot be received and the receipt is thus stopped. Consequently, there is a small danger that a return to the standby state might be delayed. Thus, the convenience of the user can be enhanced. In addition, the retrieval time and the stop time can be measured by means of one timer. Thus, the circuit can be simplified. Moreover, the control can be carried out by a processing of changing the retrieval time and the stop time only once in the middle of the repetition so that the processing can be relieved without requiring to calculate the retrieval time and the stop time for each repetition of the retrieval While there has been described the example in which the retrieval time and the stop time are changed only once in FIG. 6(c), it is also possible to vary the retrieval time and the stop time at least twice at time of a predetermined repetition.

Next, a retrieving method for causing the radio communication device in FIG. 5 to retrieve the base station (a control data retrieving method) will be described with reference to FIG. 7.

A flowchart of FIG. 7 shows a control flow in the case in which the radio communication device retrieves the control channel of a base station when it is hard to receive the control channel of the base station at time of power ON, after the end of a call or during a standby, illustrating an example in which the control for repeating the retrieval and the stop shown in FIG. 6(a) is implemented.

When the control channel of the base station is started to be retrieved, the number of times of a retrieval and an initial retrieval time T are first set to be the setting of initial values (S11). In the embodiment, the initial retrieval time is set to be 10 seconds. Subsequently, a timer is started to count a retrieval time and an elapsed time is started to be counted, and furthermore, there is executed a control for a start of a retrieval, that is, a control for setting the receiving circuit of the radio portion 101 into a state in which the control channel of the base station can be received and bringing a receiving operation state (S12). The value of the retrieval time T set at the step S11, that is, 10 seconds is/are set to be the set value of the timer which is set in the step S12 at the initial time. It is decided whether or not the base station can be received (S13) and it is decided whether or not a timer for detecting the expiration of the retrieval time expires (S14) after the start of the retrieval. If the base station is received during the receiving operation, “Yes” is obtained at the step S13 of deciding whether or not the base station can be received (S13) so that the retrieval is ended, and subsequently, the processing proceeds to an intermittent receiving operation which is synchronous with the transmitting timing of the control channel of the base station (not shown). If the state in which the control channel of the base station cannot be received is maintained continuously, the base station is successively detected until the timer expires. If the timer expires, “Yes” is obtained at the step S14 in which it is decided whether or not the timer expires so that the retrieval is stopped, that is, the receipt is stopped and the processing then proceeds to a control (S15) for setting and starting a timer for counting a halt period (there is described an example in which the halt period is set to be six seconds in the embodiment). Thereafter, it is decided whether or not the timer for counting a halt period expires (S16). If the timer expires, “Yes” is obtained at the step 16 in which it is decided whether or not the timer expires, and the processing then proceeds to a step S17 in which the number of times of the retrieval is counted up. Subsequently, the number of times of the retrieval is decided (S18). If the number of times of the retrieval is smaller than the specified number of times, the processing proceeds to a step S19 in which the retrieval time is variable corresponding to the number of times of the retrieval. If the number of times of the retrieval is equal to or greater than the specified number of times, the processing proceeds to a step S20 in which the retrieval time is set to have a fixed value. In the embodiment, it is assumed that the specified number of times for the number of times of the retrieval to be decided at the step S18 is set to be three. A control is carried out in such a manner that the retrieval time is decreased every two seconds if the number of times of the retrieval (the number of times of a retrieval retrial) does not reach the specified number of times, and the retrieval time is set to be six seconds after the number of times of the retrieval reaches the specified number of times. In the embodiment, accordingly, a next retrieval time is set to be 8 seconds if the retrieval time at a first time expires. After the next retrieval time is set at the step S19 or the step S20, the processing returns to the step S12 in which the timer for counting the retrieval time set to have the value of the retrieval time set at the step S19 or the step S20 is started and the elapsed time is started to be counted, and furthermore, there is executed the control for the start of the retrieval, that is, the control for setting the receiving circuit of the radio portion 101 into the state in which the control channel of the base station can be received and bringing the receiving operation state. Subsequently, the receiving operation for a time determined by the retrieval time T and the halt period for a constant time period (six seconds in the embodiment) are repeated until the control channel of the base station is received. In case of the embodiment, accordingly, when the control for the retrieval of the base station is started, the receiving operation for 10 seconds, the stop for 6 seconds, the receiving operation for 8 seconds, the stop for 6 seconds, and subsequently, the receiving operation for 6 seconds and the stop for 6 seconds are repeated.

While the example in which the setting of the retrieval time corresponding to the number of times of the retrieval is uniformly decreased corresponding to the retrieval time at the step S18 has been described in the embodiment, a method for first decreasing a rate at which the retrieval time is shortened and gradually increasing the rate is also effective. For example, a control is carried out in such a manner that the retrieval time for the first time is set to be 10 seconds, the retrieval time for the second time is set to be 9 seconds, the retrieval time for the third time is set to be 7 seconds, and the retrieval times for the fourth time and succeeding times are set to be 4 seconds. While two branches are provided based on the number of times of the retrieval at the step S18 in the embodiment, moreover, a plurality of branches can be provided to determine the retrieval time corresponding to the larger number of times of the retrieval. For example, it is also possible to carry out such a control that the retrieval time for the number of times of the retrieval which is smaller than 10 is set to be 10 seconds, the retrieval time for the number of times of the retrieval which is equal to or greater than 10 and is smaller than 100 is set to be 7 seconds, and the retrieval time for the number of times of the retrieval which is equal to or greater than 100 is set to be 4 seconds.

While the description has been given to the example in which the timer for setting the stop time is set to have a fixed value at the step S15 in the embodiment, moreover, it is also possible to variably control the stop time in such a manner that the rate of the stop time to the sum of the receiving operation and the stop time is increased corresponding to the number of times of the repetition as shown in FIGS. 6(b) and 6(c). While the description has been given to the example of the control flow in which the processing proceeds to each step while deciding the result of the detection of the base station and deciding the expiration of the timer through the CPU in the embodiment, furthermore, it is also possible to carry out a transition to a step through the interruption processing of the timer expiration or the receipt of the base station as described in the first embodiment.

As described above, according to the embodiment, the radio communication device for carrying out a communication with the base station for transmitting control data and receiving the control data of the base station during a standby comprises the radio portion 101 for receiving a radio signal, the counting portion 110 for counting a time required for receiving the control data transmitted periodically from the base station and a time required for stopping the radio portion 101 when the control data transmitted periodically from the base station cannot be received, and the control portion 130 for controlling the whole device, and the control portion 130 controls the radio portion 101 to receive the control data of the base station by a time determined by the counting portion 110 in order to capture the control data transmitted from the base station, controls to stop the receiving operation of the radio portion 101 by the time determined by the counting portion 110 when the control data cannot be received, repetitively controls the radio portion 101 to receive the control data of the base station by the time determined by the counting portion 110 again after the time determined by the counting portion 110 passes, and controls a time counted by the counting portion 110 in order to at least once set a receipt time to be shorter than a last receipt time and to set the rate of a receipt section to be equal to or lower than a last rate in a receipt section and a subsequent stop section when the control data of the base station cannot be received but the receipt is repeated. Consequently, it is possible to shorten a time required for consuming a current in a receipt for retrieving the base station in an environment in which a signal sent from the base station cannot be received and to lessen the current to be consumed while the signal sent from the base station cannot be received. By repeating the retrieval and the halt without prolonging a retrieval and halt period provided for reducing the consumed current in the environment in which the signal sent from the base station cannot be received, simultaneously, it is possible to reduce the delay of a return to a standby state when a receivable state is brought irrespective of a duration for which the receipt cannot be carried out. In the case in which the temporary receiving error of the base station is generated at the start of the retrieval, moreover, the control is carried out to prolong the retrieval time at the start of the retrieval. It is possible to decide that the signal sent from the base station cannot be received and to halt the retrieval, thereby lessening the delay of the return to the standby state.

### Third Embodiment

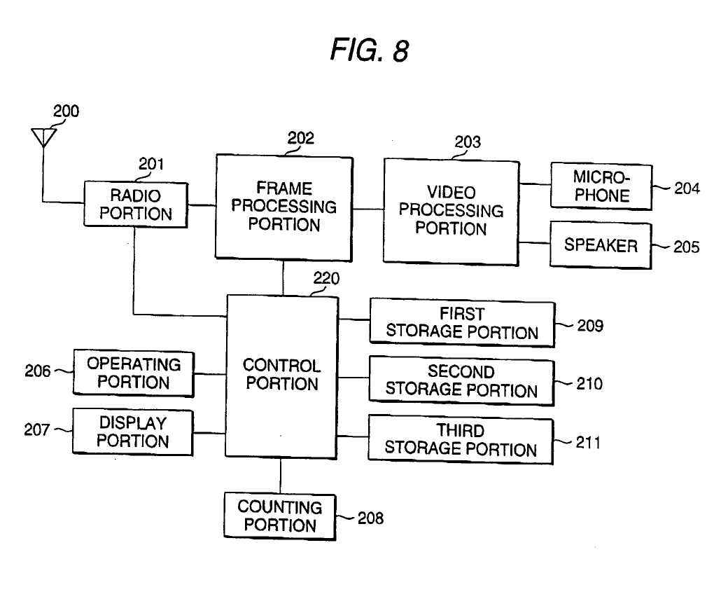

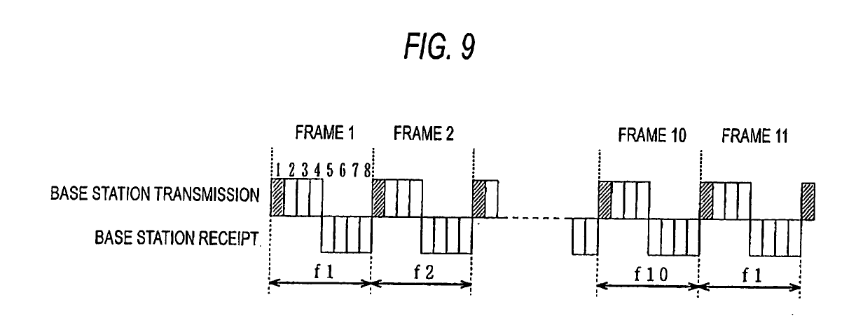

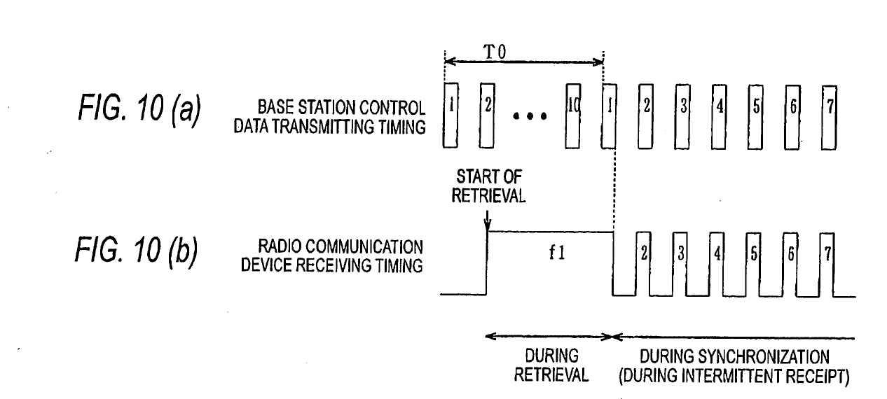

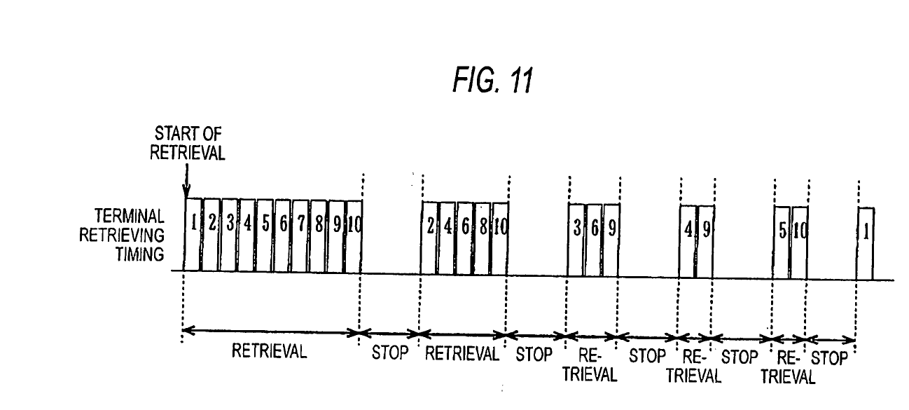

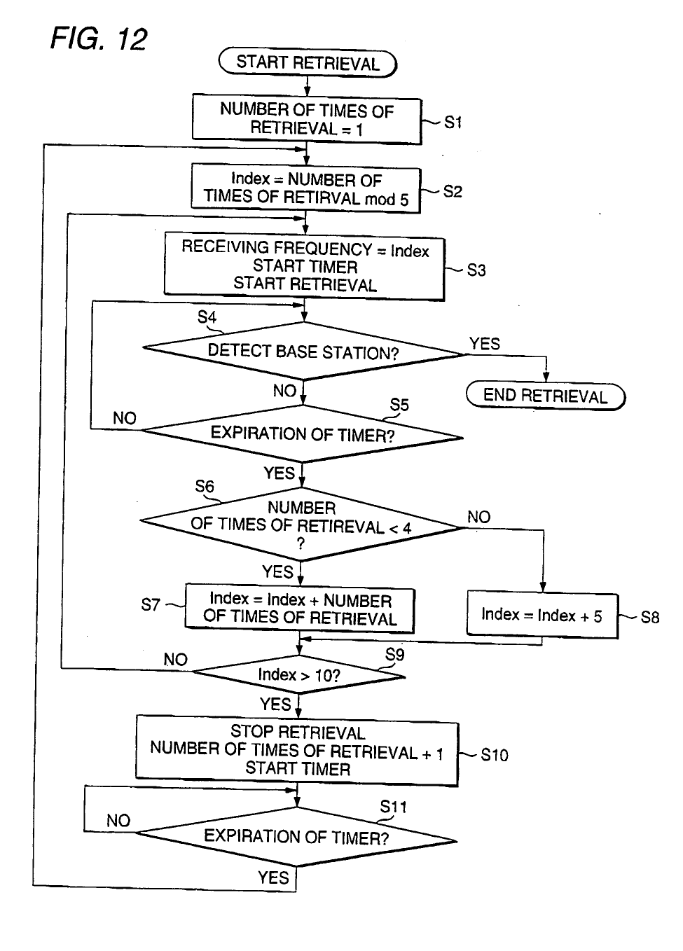

FIG. 8 is a block diagram showing a radio communication device according to a third embodiment of the invention and FIG. 9 is a timing chart showing a TDMA frame and slot and frequency hopping which are used in a communication between the radio communication device in FIG. 8 and a base station. FIG. 10(a) is a timing chart showing the transmitting timing of control data from the base station, FIG. 10(b) is a timing chart showing a receiving timing in the radio communication device, FIG. 11 is a timing chart showing an operation in which the radio communication device retrieves the transmitting signal of the control data of the base station and cannot receive the control data of the base station but repeats a retrieval and a stop, and FIG. 12 is a flowchart showing an operation in which the radio communication device retrieves the transmitting signal of the control data of the base station and cannot receive the control data of the base station but repeats the retrieval and the stop.

Moreover, (Table 1) shows a frequency and the order of use in the execution of a communication between the radio communication device and the base station with an index attached thereto.

TABLE 1

| Index | Frequency |
|---|---|
| 1 | f1 |
| 2 | f2 |
| 3 | f3 |
| 4 | f4 |
| 5 | f5 |
| 6 | f6 |
| 7 | f7 |
| 8 | f8 |
| 9 | f9 |
| 10 | f10 |

In FIG. 8, 200 denotes an antenna for transmitting/receiving a radio signal to/from a base station (not shown), 201 denotes a radio portion for generating a radio signal obtained by modulating transmission data so as to be transmitted and demodulating the radio signal which is received, 202 denotes a frame processing portion for generating a data column to be transmitted in one slot of TDMA by adding bit synchronization data, frame synchronization data or an error detection code to the transmission data, fetching voice data or control data from the received signal and carrying out an error decision, and performing an output, and 203 denotes a voice processing portion for digitally converting an analog voice signal to be transmitted and converting the received voice data to an analog voice signal. 204 denotes a microphone for inputting a voice and outputting a voice signal, 205 denotes a speaker for outputting the voice signal as a voice, and 206 denotes an operating portion for inputting a telephone number. 207 denotes a display portion for displaying the input telephone number, a date and time, a call time, the operation state of a radio communication device, and the residual quantity of a battery. 208 denotes a counting portion for counting periods of a retrieval time and a stop time in the retrieval of the base station, 209 denotes a first storage portion for storing the number of times of the retrieval, 210 denotes a second storage portion for storing the hopping pattern of frequency hopping, and 211 denotes a third storage portion for storing the frequency of the hopping pattern stored in the second storage portion 210 which is used at a next time 120 denotes a control portion for controlling the whole device.

In the following description, the radio communication device uses ten types of frequencies f1 to f10, switches the frequency in order of f1, f2, f3 . . . , and controls the frequency hopping. As shown in the (Table 1), the second storage portion 210 stores the frequencies of f1 to f10 and index numbers corresponding thereto, and the third storage portion 211 stores index numbers for specifying the frequencies stored in the second storage portion 210.

First of all, the operation of a TDMA communication through the frequency hopping will be described with reference to FIG. 9. FIG. 9 shows the frame and slot of the TDMA and the state of the frequency hopping in the execution of a communication between the base station and the radio communication device in FIG. 8. The embodiment shows the structure of the frame and slot of the TDMA in which a time base is divided into fundamental units referred to as frames, one frame is divided into eight slots, the transmitting slot of the base station is set to be four front slots (slots 1 to 4) in the frame, the receiving slot of the base station (the transmitting slot of the radio communication device) is set to be four rear slots (slots 5 to 8) in the frame, and four bidirectional multiplexing operations are carried out.

As an example of the operation of the frequency hopping, FIG. 9 shows an example in which each slot in the same frame uses the same frequency and an operation is carried out to switch the frequency to be used when the frame is varied. More specifically, in the example of FIG. 9, the slots 1 to 8 of the frame 1 carry out a communication at the frequency of f1 and the slots 1 to 8 of the frame 2 carry out the communication at the frequency of f2. In the same manner, subsequently, the frequency to be used is switched into f3, f4 . . . f10 every time the frame is varied, and f1 to f10 are used in a 10-frame cycle.

Moreover, the base station of a radio system for carrying out a TDMA communication while performing the frequency hopping transmits control data at a constant interval during an operation, and the radio communication device for waiting for the base station receives the control data transmitted from the base station and establishes the synchronization of the frequency hopping with the frame and slot, thereby performing the communication with the base station. In the embodiment, the base station transmits the control data in the first slot of each frame (the slot 1 shown in a slant line in FIG. 9). In the example of FIG. 9, moreover, the communication of the base station and a certain radio communication device is carried out in a combination of four separated slots in the frame, for instance, the slot 1 and the slot 5. The communication of the base station and another radio communication device is carried out in any of the combinations of the slot 2 and the slot 6, the slot 3 and the slot 7, and the slot 4 and the slot 8.

Description will be given to an example in which the radio communication device shown in FIG. 1 is operated in the radio system for carrying out a communication with the frequency hopping and TDMA frame and slot structure shown in FIG. 9. FIG. 10 is a timing chart for explaining an operation in which the radio communication device retrieves the transmitting signal of the control data of the base station and a transition to a standby state is performed.

First of all, the summary of an operation for the radio communication device to synchronize the frequency hopping with the frame and slot of the TDMA together with the base station through a continuous receipt will be described with reference to FIG. 10. There will be specially described the details of an intermittent receiving operation for repeating a receiving operation to carry out a synchronization in a state in which the radio communication device cannot receive a signal sent from the base station.

The control portion 120 reads a frequency having an index number of “1” in the second storage portion 210, that is, f1 and controls the radio portion 201 and the frame processing portion 202 to carry out the continuous receipt at the frequency of f1. A signal received from the antenna 200 is demodulated by the radio portion 201 and is output to the frame processing portion 202. The frame processing portion 202 detects frame synchronization data from a demodulation signal. When detecting the frame synchronization data, the frame processing portion 202 separates control data succeeding to the frame synchronization data from an error detection code and carries out an error decision over the received control data based on the error detection code thus separated, and gives the notice of the control data to the control portion 120 if an error is not made. The control portion 120 to which the notice of the control data is given can select the base station based on the ID of the base station which is included in the control data.

In the case in which a transition to a synchronization state with the received base station is to be carried out, the control portion 120 subsequently performs a control to receive one slot in a one-frame cycle, updates a value stored in the third storage portion 211 every receipt, and controls the radio portion 201 to execute a receipt while sequentially switching a frequency to be read from the second storage portion 210. More specifically, when receiving the control data to be transmitted from the base station at the frequency of f1 during the continuous receipt, the control portion 120 controls the radio portion 201 and the frame processing portion 202 to write an index=2 indicative of a next frequency to the third storage portion 211 and to stop the continuous receipt. Then, the control portion 120 controls the radio portion 201 and the frame processing portion 202 to start the receipt corresponding to the transmitting timing of the control data transmitted from the base station one frame after, and reads an index stored in the third storage portion 211, that is, “2 ” and reads a frequency corresponding thereto, that is, f2 from the second storage portion 210 to set a receiving frequency Moreover, the index stored in the third storage portion 211 is updated to “3” to prepare for a next receipt.

Moreover, the control portion 120 continuously receives the control data of the base station and receives information about a transmitting slot included in the control data, and knows the slot position of the control data transmitted from the base station and establishes the synchronization of the slot as described above. More specifically, in the case in which the transmission of the control data from the base station is carried out in the slot 1 of each frame as shown in FIG. 9, the base station transmits the control data to be sent in the first slot including data for periodically giving a notice that the transmitting slot is “1”, and the radio communication device receiving the notice subsequently sets the timings of the frame and the slot in such a manner that the receiving slot of the control data transmitted from the base station makes one slot and establishes the synchronization of the frame and slot with the base station.

FIG. 10 shows an operation for the radio communication device described above to carry out a synchronization with the transmitting slot of the control data of the base station. As shown in FIG. 10, when the retrieving operation is started, the radio communication device starts the continuous receipt at the frequency of f1. The base station transmits the control data while switching the frequency in order of f1, f2 . . . f10. When the base station transmits the control data at the frequency of f1, the control data of the base station are received by the radio communication device and a transition from the continuous receipt to an intermittent receipt in a frame cycle is carried out, and a control for sequentially switching the receiving frequency in order of f2, f3 . . . is started.

Next, description will be given to the operations of the radio communication device and the base station during a call.

The radio communication device shown in FIG. 8 can carry out a communication in a voice with another telephone or radio communication device through the base station. In the case in which a call is given from the radio communication device to another device, a user inputs the telephone number of the other party and a call key for giving a request for a call from the operating portion 206 and performs a transmission. When the transmitting operation is carried out by the operating portion 206, the control portion 120 sends the control data for calling the base station to the frame processing portion 202 and the frame processing portion 202 adds bit synchronization data, frame synchronization data and an error detection code to the control data transmitted from the control portion 120 corresponding to the receiving timing of the base station and outputs them to the radio portion 201, and a data column output from the frame processing portion 202 is converted to a radio signal through the radio portion 201 and the same radio signal is transmitted from the antenna 200. At this time, the control portion 120 establishes the synchronization of the frequency hopping with the frame and slot and controls the transmitting timing in such a manner that the control data for calling the base station are transmitted in a receiving slot corresponding to a slot for transmitting the control data of the base station as described above. More specifically, in the case in which the base station transmits the control data in the first slot as shown in FIG. 9, the radio communication device transmits the control data for calling the base station in a fifth slot at the same frequency as the receiving frequency of the first slot.

Then, the control portion 120 controls the radio portion 201 and the frame processing portion 202 in order to wait for a response sent from the base station while switching the frequency every frame, receives the response from the base station and executes the exchange of the control data for a calling connection after receiving the response from the base station. When receiving, from the base station, a notice that the other party sends a response, the control portion 120 controls the frame processing portion 202 and the voice processing portion 203 so as to start a voice call, and the voice signal thus received is subjected to an analog conversion by the voice processing portion 203 and is thus output from the speaker 205, and a voice input from the microphone 204 is converted into a voice signal and the voice signal is subjected to a digital conversion by the voice processing portion 203 and is processed by the frame processing portion 202, and is converted into a radio signal by the radio portion 201 and is thus output so that the voice call is started.

When giving a call from another device to the radio communication device, moreover, the base station transmits the control data for giving the notice of an incoming call to the radio communication device and gives the notice of the incoming call to the radio communication device. For this reason, the radio communication device is operated to receive the control data of the base station in a state other than the call. When receiving the control data for giving the notice of the incoming call, the radio communication device exchanges the control data for a call control together with the base station in the same manner as in the transmitting operation described above, and the control portion 120 controls the display portion 207 to display the notice of the incoming call and carries out a control to start the voice call when a user performs an operation for responding to the incoming call through the operating portion 206.

Next, description will be given to the details of an intermittent receiving operation for the radio communication device set in a state in which a signal cannot be received from the base station to repeat a receiving operation in order to synchronize the frequency hopping with the frame and slot of the TDMA together with the base station.

The radio communication device receives the control data transmitted from the base station and synchronizes the frequency hopping with the frame and slot together with the base station, and is thus brought into a communication state or a standby state at the start of a call or the end of the call as described above. If a situation in which the signal cannot be received from the base station is maintained continuously, the receipt and the stop are repeated for a constant time period until the control data of the base station can be received.

More specifically, when an operation for carrying out the synchronization with the base station is started, the control portion 120 first sets, as an index, a remainder obtained by dividing the number of times of the retrieval stored as the index of the start of the retrieval (a code indicative of a frequency to be selected) in the first storage portion 209 by a predetermined value (there will be hereinafter described an example in which this value is five) to the third storage portion 211, reads a frequency corresponding to the index thus set from the second storage portion 210, controls the radio portion 201 and the frame processing portion 202 to start the receipt at the frequency thus read, and sets a time required for the continuous receipt to the counting portion 208.

When the control data of the base station cannot be received but the continuous receipt time counted by the counting portion 208 passes during the continuous receipt, the counting portion 208 gives the notice of the expiration of counting to the control portion 120. The control portion 120 receiving the notice of the expiration of counting reads the number of times of the retrieval which is stored in the first storage portion 209. If the number of times of the retrieval stored in the first storage portion is equal to or smaller than a predetermined number of times (there will be hereinafter described an example in which this number of times is three), the index of the frequency stored in the third storage portion 211 is updated by a number which is equal to the number of times of the retrieval read from the first storage portion 209.

If the number of times of the retrieval which is stored in the first storage portion 209 is greater than the predetermined number of times, the index of the frequency stored in the third storage potion 211 is updated by a predetermined number (there will be hereinafter described an example in which this value is five). A frequency corresponding to the index thus updated is read from the second storage portion 210 in the same manner as described above until the index obtained after the update exceeds the maximum value of the index (10 in the example, of the (Table 1)), and the radio portion 201 and the frame processing portion 202 are controlled to carry out the receipt at the frequency thus read. At that time, a time required for the continuous receipt is set to the counting portion 208 and the receipt is carried out until the receipt time counted by the counting portion 208 expires, and the index is updated, that is, the frequency is varied, and at the same time, the receipt is carried out again in the same manner as described above.

If the index obtained after the update exceeds the maximum value of the index (10 in the example of the (Table 1)), the control portion 120 controls the radio portion 201 and the frame processing portion 202 into a state in which the receipt is stopped, increments the number of times of the retrieval which is stored in the first storage portion 209, and sets a stop time to the counting portion 208.

When the stop time expires and the notice of the expiration of the stop time is given from the counting portion 208 to the control portion 120, then, the control portion 120 controls each portion in the same manner as an operation to be carried out at the start of the retrieval and restarts a receipt for retrieving the control data of the base station, and subsequently, repeats a receipt with a frequency switched until the control data of the base station are received and the stop of the receipt, and at the same time, repeats an operation for retrieving the control data of the base station in the same manner as described above. When the receipt can be carried out, the number of times of the retrieval in the first storage portion 209 is returned to “1” and the operation described in the summary of the operation for the radio communication device to synchronize the frequency hopping with the frame and slot of the TDMA together with the base station is carried out to proceed to a synchronization state.

Next, description will be given to the switching of a receiving frequency in the retrieval of the base station to be carried out by the radio communication device through the control in the case in which a hopping frequency is constituted by 10 types of frequencies of f1, f2 . . . f10 as shown in the (Table 1). FIG. 11 shows the timing of an operation in which the radio communication device cannot receive the control data of the base station but repeats the receiving operation and the receipt stop while varying a frequency. In FIG. 11, the frequency is shown in only a figure and f is omitted.

In the embodiment, the receipt is started in order from a frequency corresponding to an index which is equal to a remainder obtained by dividing the number of times of the retrieval by 5. The index is updated by a number (one at a first time) which is equal to the number of times of the retrieval to switch the receiving frequency from the first to third times for the retrieval. When the number of times of the retrieval exceeds three, the index is updated by fixed five to switch the receiving frequency. When the index obtained after the update exceeds the maximum value of the index=10, the receipt stop state is brought and the receipt is stopped for a time period counted by the counting portion 208 (a halt period).

When the retrieval of the base station is started, the receipt is started in order from the frequency of f1 corresponding to the index of a remainder of 1 which is obtained by dividing the number of times of the retrieval by five in the retrieval at a first time. Since the number of times of the retrieval is equal to or smaller than three, the index is updated by one which is equal to the number of times of the retrieval. The frequency to be received is switched to f1, f2 . . . f10, and at the same time, the receipt is carried out for a constant time period respectively. After the end of the receipt at f10, the receipt is stopped for a time period counted by the counting portion 208 because a value obtained by adding the number of times of the retrieval=1 which is stored in the first storage portion 209 to the index=10 stored in the third storage portion 211 exceeds the maximum value of the index=10. Moreover, the number of times of the retrieval in the first storage portion 209 is incremented to “2” for a next retrieval.

Then, a retrieval for a second time is started after the stop time counted by the counting portion 208. In the retrieval for the second time, the receipt is started in order from the frequency of f2 corresponding to the index of 2 to be a remainder obtained by dividing the number of times of the retrieval by 5. Since the number of times of the retrieval is equal to or smaller than three, the index is updated by two which is equal to the number of times of the retrieval and the frequency to be received is switched to f2, f4 . . . f10, and at the same time, the receipt is carried out for a constant time period, respectively. After the end of the receipt at f10, a value obtained by adding the number of times of the retrieval=2 which is stored in the first storage portion 209 to the index=10 stored in the third storage portion 211 exceeds the maximum value of the index=10. Therefore, the receipt is stopped for the time period counted by the counting portion 208. For a next retrieval, moreover, the number of times of the retrieval of the first storage portion 209 is incremented to “3”.

Similarly, a retrieval for a third time is started after the stop time counted by the counting portion 208. In the retrieval for the third time, the receipt is started in order from the frequency of f3 corresponding to the index of 3 to be a remainder obtained by dividing the number of times of the retrieval by 5. Since the number of times of the retrieval is equal to or smaller than three, the index is updated by three which is equal to the number of times of the retrieval and the frequency to be received is switched to f3, f6 and f9, and at the same time, the receipt is carried out for a constant time period, respectively. After the end of the receipt at f9, a value obtained by adding the number of times of the retrieval=3 which is stored in the first storage portion 209 to the index=9 stored in the third storage portion 211 exceeds the maximum value of the index=10. Therefore, the receipt is stopped for the time period counted by the counting portion 208. For a next retrieval, moreover, the number of times of the retrieval of the first storage portion 209 is incremented to “4”.

Then, a retrieval for a fourth time is started after the stop time counted by the counting portion 208. In the retrieval for the fourth time, the receipt is started in order from the frequency of f4 corresponding to the index of 4 to be a remainder obtained by dividing the number of times of the retrieval by 5. Since the number of times of the retrieval exceeds three, the index is updated by five and the frequency to be received is switched to f4 and f9, and at the same time, the receipt is carried out for a constant time period, respectively. After the end of the receipt at f9, a value obtained by adding five to the index=9 stored in the third storage portion 211 exceeds the maximum value of the index=10. Therefore, the receipt is stopped for the time period counted by the counting portion 208. For a next retrieval, moreover, the number of times of the retrieval of the first storage portion 209 is incremented to “5”.

In the same manner as in the retrieval for the fourth retrieval, subsequently, the frequency is switched to f5 and f10, and at the same time, the receipt is carried out for a constant time period respectively in a retrieval for a fifth time, and the frequency is switched to f1 and f6, and at the same time, the receipt is carried out in a retrieval for a sixth time. Thus, the receipt and the receipt stop are repeated at two frequencies.

As shown in FIG. 11, when the retrieving operation is started in the radio communication device in a situation in which the control data of the base station cannot be received, the frequency is switched to f1, f2 . . . f10, and at the same time, the receiving operation is carried out for a constant time period and the receiving operation is then halted. Then, the continuous receipt is restarted, and the frequency is switched to f2, f4 . . . f10, and at the same time, the receiving operation is carried out for a constant time period and the receiving operation is thereafter halted. Similarly, the number of the frequencies at which the receiving operation is carried out is decreased, and at the same time, the receiving operation and the receipt stop are repeated. Finally, two types of frequencies are switched, and at the same time, the receiving operation and the receipt stop are repeated. Thus, the control data of the base station are received. A time required for the receiving operation at each frequency is controlled to be a time having at least one cycle for switching the transmitting frequency of the control data of the base station, that is, a time of T0 or more in FIG. 10, and is determined in such a manner that the base station transmits the control data at a pertinent frequency at least once within the time required for the receiving operation at each frequency and the control data can be received by the radio communication device.

Next, a retrieving method for causing the radio communication device to retrieve the base station (a control data retrieving method) will be described with reference to FIG. 12.

A flowchart of FIG. 12 shows a control flow in the case in which the radio communication device retrieves the control channel of a base station when it is hard to receive the control channel of the base station at time of power ON, after the end of a call or during a standby.

When the retrieval of the control channel of the base station (that is, the retrieval of the control data) is started, the number of times of the retrieval=1 is first set as the setting of an initial value (S1) and an index (indicated as Index in FIG. 12) for determining a retrieving frequency is calculated (S2). It is not necessary to set the initial value of the number of times of the retrieval at the step S1 when the same initial value has already been set for a next retrieval at the end of the retrieval. Moreover, “mod” at the step S2 implies a remainder obtained by a division, and there is shown an example in which a remainder obtained by dividing the number of times of the retrieval by five is set to be the value of the index. Subsequently, a receiving frequency is set to be the frequency indicated by the index and a timer for measuring a receipt time is started to execute a control for the start of the retrieval, that is, such a control as to set a receiving circuit into a state in which the control channel of the base station can be received and to bring a receiving operation state.

It is decided whether or not the base station can carry out the receipt (S4) and it is decided whether or not a timer for monitoring the expiration of the receipt time expires (S5) after the start of the retrieval. If the base station is received during the receiving operation, “Yes” is obtained at the step S4 at which it is decided whether or not the base station can be received, and the retrieval is ended, and subsequently, the processing proceeds to an intermittent receiving operation which is synchronous with the transmitting timing of the control channel of the base station (not shown). If the state in which the control channel of the base station cannot be received is maintained continuously, the base station is successively detected until the timer expires. If the timer expires, “Yes” is obtained at the step S5 in which it is decided whether or not the timer expires. Then, the processing proceeds to a step S6 in which the number of times of the retrieval is decided.

If the number of times of the retrieval is smaller than a specified number of times (four) at the step S6, the processing proceeds to a step S7 in which the index is updated corresponding to the number of times of the retrieval. If the number of times of the retrieval is equal to or greater than the specified number of times, the processing proceeds to a step S8 in which the index is updated by a predetermined value (+5). After the index is updated at the step S7 or the step S8, it is decided whether or not the index exceeds the maximum value (10) of the index (S9). If the index does not exceed the maximum value, the processing returns to the step S3 in order to receive a next frequency. If the index exceeds the maximum value, moreover, the retrieval is stopped, that is, the receiving circuit is turned OFF, the number of times of the retrieval is incremented and the timer is started in order to count the stop time (S10). Then, it is repetitively decided whether or not the timer expires (S11). If the timer expires, the processing proceeds to “Yes” and returns to the step S2 so that the receipt for the retrieval is started again.

As described above, according to the embodiment, in the case in which the control data transmitted from the base station cannot be captured but the receipt and the stop of the radio portion 201 are repeated many times, it is possible to gradually shorten a receipt time while decreasing the number of frequencies to be received and to repeat a retrieval and a halt without prolonging a retrieval and halt period provided in order to reduce a consumed current. Irrespective of a duration for a state in which the receipt cannot be carried out, therefore, it is possible to reduce the delay of a return to a standby state when a state in which the receipt can be carried out is brought. In the case in which the temporary receiving error of the base station or the stationary error of a fixed frequency is generated at the start of the retrieval, moreover, a control is carried out to increase the number of frequencies for a retrieval at the start of the retrieval. Therefore, it is possible to decide that a signal sent from the base station cannot be received and to halt the retrieval, thereby lessening the delay of the return to the standby state.

Moreover, a control is carried out to vary a frequency selected in the receipt in the case in which the control data transmitted from the base station cannot be captured but the receipt and the stop of the radio portion 201 are repeated many times. In the case in which a part of the frequency used in the transmission of the control data cannot be received due to an interference, consequently, a control is carried out to vary a frequency to be retrieved when the retrieval and the stop are repeated. Even if the receiving error is generated in a part of the transmitting frequency of the control data due to a radio interference, therefore, it is possible to prevent a decision of receipt disabled from being made by the repetition of the retrieval at only a frequency generating the receiving error due to the interference. Thus, it is possible to lessen the delay of the return to the standby state, resulting in a reduction in a consumed current through a halt period.

While the description in the embodiment has been given to the example in which the receipt and the stop are repeated with a variation in a receiving frequency when the radio communication device repeats a retrieving operation in an environment in which the control data of the base station cannot be received, the number of frequencies to be received is decreased down to a constant number of times, and then, the number of the frequencies to be received is fixed to repeat the receipt and the stop while varying only the frequency, it is also possible to carry out an operation for fixing the number of frequencies to be received from the start of the retrieval and repeating the receipt and the stop while varying only the frequency. Moreover, it is also possible to employ a method for repeating the receipt and the stop while varying the receiving frequency, decreasing the number of frequencies to be received down to a constant number of times, and then, fixing the number of the frequencies to be received and the frequencies to repeat the receipt and the stop from the start of the retrieval. Thus, it is possible to produce an advantage that a control for determining the receiving frequency can be simplified.

While the description in the embodiment has been given to the example in which the receipt and the stop are repeated with a variation in a receiving frequency when the radio communication device repeats a retrieving operation in an environment in which the control data of the base station cannot be received, the number of frequencies to be received is decreased down to a constant number of times, and then, the number of the frequencies to be received is fixed to repeat the receipt and the stop while varying only the frequency, furthermore, it is also possible to employ a method for fixing the number of frequencies to be received and carrying out a receipt until the receipt and a stop are repeated at a constant number of times from the start of the retrieval, and decreasing and fixing the number of the frequencies to be received and carrying out the receipt after a transition to the constant number of times. Consequently, it is possible to produce an advantage that a control for determining the receiving frequency can be simplified.

While the description has been given to the example in which the time required for the receiving operation at each frequency in the repetition of the receipt and the stop is set to be constant in the embodiment, moreover, it is also possible to carry out such a control as to prolong the time required for the receiving operation at each frequency in the start of the retrieval and to shorten the same time in the middle. In this case, the time required for the receiving operation at the same frequency is taken to be long at the start of the receipt. In the case in which the control data of the base station cannot be received due to a temporary radio error, therefore, it is decided that the receipt cannot be carried out at a pertinent frequency and the case of switching to a next frequency is decreased. Consequently, it is possible to relieve the waste of a power consumed in the stable time of a transmitting circuit such as a synthesizer for switching a receiving frequency.

While the description has been given to the example in which the time required for stopping the receipt in the repetition of the receipt and the stop is set to be constant in the embodiment, furthermore, it is also possible to variably control the time required for the receipt stop. By gradually prolonging the stop time when repeating the receipt and the stop, it is possible to more reduce a consumed current. By decreasing the total time of each receiving operation in order to reduce the rate of the stop time in the total time of each receiving operation for one-time and the sum of subsequent stop times, and simultaneously decreasing the stop time at the rate or more, moreover, it is possible to return to a synchronization state earlier when bringing a receivable state while reducing the consumed current.

This application is based upon and claims the benefit of priority of Japanese Patent Application No2003-396903 filed on Mar. 11, 1927 and Japanese Patent Application No2003-405386 filed on Mar. 12, 2004, the contents of which are incorporated herein by references in its entirety

1. A radio communication device for carrying out a communication with a base station, comprising:
a radio portion, capable to receive a control data transmitted from the base station,
in case that the control data cannot be received, an intermittent receiving operation is carried out,
during the intermittent receiving operation, the radio portion is controlled to stop a receiving operation after a predetermined receiving period, and the radio portion is controlled to restart the receiving operation after a predetermined halt period,
in case such that the control data can not be captured for the predetermined receiving period, the predetermined receiving period is switched.

2. The radio communication device according to claim 1, comprising:
during the intermittent receiving operation, in case such that the control data cannot be captured for the determined receiving period, the predetermined receiving period and the predetermined halt period are switched.

3. A radio communication device for carrying out a communication with a base station for periodically transmitting control data and receiving the control data of the base station during a standby, comprising:
a radio portion, receiving a radio signal; and
a control portion;
wherein, in case of carrying out an intermittent receiving operation so as to capture the control data transmitted from the base station during a standby,
the control portion control the radio portion to start a receiving operation so as to periodically receive the control data of the base station;
in case that the control data cannot be received for a predetermined receiving period, the control portion control the radio portion to stop the receiving operation and restart the receiving operation after a receiving stop state is brought; and
in case such that the control data transmitted from the base station cannot be captured for the predetermined period, the control portion switch the predetermined receiving period to be short.

4. The radio communication device according to claim 3, wherein:
in case such that the control data of the base station cannot be received and the receiving operation is repeated at a predetermined number of times in the intermittent receiving operation,
the control portion changes a receipt time to be shorter than a last receipt time and reduces a rate of a receiving section and a receiving section in a succeeding stop section to be lower than a last rate.

5. The radio communication device according to claim 3, wherein:
in case such that the control data of the base station cannot be received and the receiving operation is repeated at a predetermined number of times in the intermittent receiving operation,
the control portion controls to switch the receiving period to be short without varying the halt period.

6. The radio communication device according to claim 4, further comprising:
a counting portion, counting a receipt period for receiving control data transmitted periodically from the base station and a halt period for stopping the radio portion in case that the control data transmitted periodically from the base station cannot be received,
wherein the control portion the counting portion to stepwise reduce a receipt time to be shorter than a last receipt time and to stepwise decrease a rate of a receiving section and a receiving section in a succeeding stop section to be lower than a last rate.

7. The radio communication device according to claim 5, further comprising:
a counting portion, counting a receiving period for receiving control data transmitted periodically from the base station and a halt period for stopping the radio portion in case that the control data transmitted periodically from the base station cannot be received,
wherein the control portion controls the counting portion to switch the receiving period to be short without varying the halt period when the control data of the base station cannot be received but the receipt is repeated at a predetermined number of times in the intermittent receiving operation.

8. The radio communication device according to claim 3, further comprising:
a first counting portion, counting a time required for receiving control data transmitted periodically from the base station; and
a second counting portion, counting a halt period from a stop of a receiving operation to a start of a next receiving operation during the intermittent receiving operation;
wherein the control portion controls the radio portion to receive the control data of the base station for a predetermined time by the first counting portion and controls to start the receiving operation after a time determined by the second counting portion passes after the stop of the receiving operation when the control data cannot be received in the intermittent receiving operation.

9. A radio communication device for partitioning a predetermined cycle by a plurality of temporal slots to carry out a time division communication, thereby communicating with a base station for transmitting control data and for receiving the control data of the base station during a standby, comprising:
a radio portion, receiving a radio signal;
and a control portion;
wherein in carrying out an intermittent receiving operation so as to capture the control data transmitted from the base station during a standby,
the control portion control the radio portion to start a receiving operation so as to receive the control data,
in case that the control data cannot be received for a predetermined receiving period, the control portion control the radio portion to stop the receiving operation and then to restart the receiving operation after a predetermined halt period passes, and
in case that the control data transmitted from the base station cannot be captured for a predetermined period, the control portion controls to switch the receiving period to be short and to decrease the number of frequencies to be selected for the receiving period.

10. The radio communication device according to claim 9, wherein:
in case such that the control data transmitted from the base station cannot be captured for the predetermined period, a control is carried out to switch the receiving period to be short without varying the halt period.

11. A radio communication device which carries out a communication with a base station for transmitting control data by using a frequency hopping method for partitioning a predetermined cycle by a plurality of temporal slots to perform a time division communication and for executing a transmission while varying a transmitting frequency in predetermined order every slot, and receives the control data of the base station during a standby, comprising:
a radio portion receiving a radio signal; and
a control portion;
wherein in case of carrying out an intermittent receiving operation so as to capture the control data transmitted from the base station during a standby,
the control portion control the radio portion to start a receiving operation so as to receive any of frequencies used in the transmission of the control data of the base station,
in case such that the control data cannot be received for a predetermined receiving period, the control portion control the radio portion to stop the receiving operation and to then restart the receiving operation after a predetermined halt period passes, and
in case such that the control data transmitted from the base station cannot be captured for the predetermined period, the control portion controls to switch a receiving period of the intermittent receiving operation to be short and to change a frequency to be selected for the receiving period.

12. A control data retrieving method for retrieving control data transmitted from a base station for transmitting the control data in a radio communication device for carrying out a communication with the base station and receiving the control data of the base station during a standby, comprising:
a retrieval time determining step of determining a retrieval time;
a receiving step of carrying out a receipt for retrieving the base station for the retrieval time determined at the retrieval time determining step;
a receipt stopping step of stopping the receipt when the control data of the base station cannot be received within the determined retrieval time;
a retrieval start cycle measuring step of measuring a retrieval start cycle; and
a retrieval time reducing step of determining the retrieval time determined at the retrieval time determining step to be equal to or shorter than a last retrieval time to proceed to the receiving step after an expiration of the retrieval cycle when the control data of the base station cannot be received within the retrieval time.

13. A control data retrieving method for retrieving control data transmitted from a base station for transmitting the control data in a radio communication device for carrying out a communication with the base station and receiving the control data of the base station during a standby, comprising:
a retrieval time determining step of determining a retrieval time;
a receiving step of carrying out a receipt for retrieving the base station for the retrieval time determined at the retrieval time determining step;
a receipt stopping step of stopping the receipt when the control data of the base station cannot be received within the determined retrieval time;
a stop time determining step of determining a stop time for stopping the receipt and determining the stop time at and after a next time in order to set a rate of a receipt time occupied in a sum of the retrieval time and the stop time to be equal to or lower than a last rate; and
a retrieval time reducing step of determining the retrieval time determined at the retrieval time determining step to be shorter than a last receipt time at least once to proceed to the receiving step after the stop time passes.

14. A control data retrieving method for retrieving control data transmitted from a base station for transmitting the control data in a radio communication device for carrying out a communication with the base station by using a frequency hopping method for performing a transmission while varying a transmitting frequency in predetermined order and receiving the control data of the base station during a standby, comprising:
a frequency determining step of determining at least one retrieval frequency;
a receiving step of carrying out a receipt for retrieving the base station at the frequency thus determined;
a receipt stopping step of stopping the receipt when the control data of the base station cannot be received for a period of the receipt for the retrieval; and
a cycle measuring step of measuring a retrieval start cycle,
wherein if the control data of the base station cannot be received for the period of the receipt for the retrieval at the frequency determining step, a number of present retrieving frequencies is determined to be smaller than that of last retrieving frequencies after an expiration of the retrieval cycle.

15. A control data retrieving method for retrieving a transmitting signal of control data transmitted from a base station for transmitting the control data in a radio communication device for carrying out a communication with the base station by using a frequency hopping method for performing a transmission while varying a transmitting frequency in predetermined order and receiving the control data of the base station during a standby, comprising:
a frequency determining step of determining at least one retrieval frequency;
a receiving step of carrying out a receipt for retrieving the base station at the frequency thus determined;
a receipt stopping step of stopping the receipt when the control data of the base station cannot be received for a period of the receipt for the retrieval, and a cycle measuring step of measuring a retrieval start cycle,
wherein if the control data of the base station cannot be received for the period of the receipt for the retrieval at the frequency determining step, at least one of present retrieving frequencies to be selected is determined to be different from a last retrieving frequency after an expiration of the retrieval cycle.
